(19) United States
(12) Patent Application Publication
(10) Pub. No.: US 2026/0178707 A1
(43) Pub. Date: Jun. 25, 2026

(54) METHOD FOR THEFT PROTECTION OF MACHINE LEARNING MODULES, AND PROTECTION SYSTEM

(71) Applicant: Siemens Aktiengesellschaft, München (DE)

(72) Inventors: Anja von Beuningen, Erfurt (DE); Michel Tokic, Tettnang (DE); Boris Scharinger, Fürth (DE)

(21) Appl. No.: 18/727,428

(22) PCT Filed: Dec. 19, 2022
(86) PCT No.: PCT/EP2022/086799

§ 371 Date: Jul. 9, 2024

(30) Foreign Application Priority Data
Jan. 14, 2022 (EP) 22151571.1

(51) Int. Cl. G06F 21/16; G06N 3/08

(52) U.S. Cl. CPC G06F 21/16; G06N 3/08

(57) ABSTRACT

A method is provided for theft protection of a machine learning module which is trained, to derive, from operating signals of a machine, control signals for controlling the machine, a distribution of the training data in a representation space of the operating signals is determined in spatial resolution. The machine learning module is also expanded by an additional input layer, and the expanded machine learning module is transmitted to a user. When input signals are fed into the expanded machine learning module, a location of a relevant input signal in the representation space is determined by the additional input layer. Moreover, depending on the distribution of the training data, a coverage value specifying coverage of the location of each input signal by the training data is determined in each case. Finally, depending on the determined coverage values, in the event of low coverage values, an alarm signal is output.

### CROSS-REFERENCE TO RELATED APPLICATIONS

This application is a national stage of PCT Application No. PCT/EP2022/086799, having a filing date of Dec. 19, 2022, claiming priority to EP Application Serial No. 22151571.1, having a filing date of Jan. 14, 2022, the entire both contents of which are hereby incorporated by reference.

### FIELD OF TECHNOLOGY

The following relates to a method for theft protection of machine learning modules, and a protection system for same.

### BACKGROUND

Complex machines, such as robots, engines, manufacturing plants, machine tools, gas turbines, wind turbines or motor vehicles generally require complex control and monitoring procedures for productive and stable operation. For this purpose, machine learning techniques are often used in modern machine control systems. For example, a neural network as a control model can be trained to control a machine in an optimized manner.

However, training neural networks or other machine learning modules to control complex machines is often very time-consuming. As a rule, large amounts of training data, significant computing resources and a great deal of specific expert knowledge are required. There is therefore great interest in protecting trained machine learning modules or any training information contained therein against uncontrolled or unauthorized dissemination or use and/or detecting incidents of theft.

It is conventional to protect neural networks against theft by providing their neural weights with a unique digital watermark before they are made available. Using the watermark, an existing neural network can then be checked to determine whether it originates from the user of the watermark. Such methods, however, offer little protection against so-called model extraction, in which a possibly marked neural network is used to train a new machine learning module to behave similarly to the neural network. In this case, a watermark imprinted on neuronal weights is usually no longer reliably detectable in the newly trained machine learning module.

In the Internet document https://www.internet-sicherheit.de/research/cybersicherheit-und-kuenstliche-intelligenz/model-extraction-attack.html (accessed on 16.12. 2021), several methods for protection against model extraction and their problems are discussed.

### SUMMARY

An aspect relates to a method for theft protection of a machine learning module and a corresponding protection system, which provide better protection against model extraction.

According to embodiments of the invention, to provide theft protection of a machine learning module which is trained on the basis of training data to derive control signals for controlling a machine from operating signals of a machine, a distribution of the training data in a representation space of the operating signals is determined in spatial resolution. Furthermore, the machine learning module is extended by an additional input layer, and the extended machine learning module is transmitted to a user. When input signals are fed into the extended machine learning module, a location of each input signal in the representation space is determined by the additional input layer. In addition, depending on the distribution of the training data, a coverage value specifying coverage of the location of each input signal by the training data is determined. Finally, depending on the calculated coverage values, an alarm signal is output, in particular in the event of low coverage values.

For the implementation of the method according to embodiments of the invention a protection system, a computer program product (non-transitory computer readable storage medium having instructions, which when executed by a processor, perform actions), and a machine-readable, non-volatile, storage medium are provided.

In embodiments the method according to the invention and the protection system according to the invention can be embodied or implemented, for example, by one or more computers, processors, application specific integrated circuits (ASIC), digital signal processors (DSP) and/or so-called Field Programmable Gate Arrays (FPGA). In embodiments, the method according to the invention can be carried out at least partially in a cloud and/or in an edge computing environment.

Embodiments of the invention offer efficient and relatively secure protection for machine learning modules against unauthorized model extraction. In embodiments, the method is based on the observation that, when attempting a model extraction, a representation space of the input signals of the machine learning module is usually sampled systematically and/or randomly. However, the input signals sampled in this way usually have a different statistical distribution than the operating signals of the machine used for training. This means that insufficient coverage of input signals by training data can be interpreted as an indication of a model extraction. In addition, embodiments of the invention are flexibly applicable and in particular not limited to artificial neural networks.

According to an embodiment of the invention, the distribution of the training data can be stored in the additional input layer as a spatially resolved density field. A density value of the density field at the location of the respective input signal can then be determined as the respective coverage value. Regions with high density values can be seen here as regions of the representation space that are well covered by the training data. A density field can in particular represent a density of the training data in dependence on or as a function of coordinates of the representation space.

According to an embodiment of the invention, on the basis of the distribution of the training data, a confidence region can be determined in the representation space, which comprises a predetermined proportion of the training data. The confidence region can be stored in the additional input layer. The respective coverage value can then be determined depending on the distance of the location of the respective input signal from the confidence region. Increasing distances can be assigned smaller coverage values, in particular by a monotonically decreasing function, for example the reciprocal function. Furthermore, a maximum coverage value, e.g., a value of 1, can be determined if a location of a respective input signal is located within the confidence region. Outside of the confidence region, a coverage value of 0 or a coverage value that falls with the distance can then be assigned.

The confidence region can be determined in particular on the basis of the density field. Thus, the confidence region can also be determined as the part of the representation space for which the training data density is above a predetermined threshold value. The confidence region or parts thereof can be represented by a respective center and a respective outline or radius, and stored in this representation. In embodiments, a distance of the location of the respective input signal from a center or from an edge of the confidence region can be determined as the distance.

According to an embodiment of the invention, the distribution of the training data can be determined by a density estimator. Such density estimators are available in many implementations.

In embodiments, the density estimator, the training data can be grouped into clusters by a cluster analysis and a cluster center can be determined for each cluster. For a particular cluster center, a distribution of the training data of the relevant cluster in the representation space can be represented by parameterizing a predetermined density function. For the cluster analysis, the density estimator can be trained in particular by unsupervised machine learning methods, e.g., by so-called k-means methods. The density function can be parameterized by the relevant cluster center as well as a variance of the training data belonging to the relevant cluster. In the multidimensional case, the variance can be represented by a covariance matrix. A density field defined in the representation space can be represented by an optionally weighted sum of the cluster-specific density functions.

In embodiments, a radially symmetric distribution function can be used as a density function. For example, a Gaussian function parameterized by a mean value MY and a variance S

$$F ( X ) = N * exp ( - 1 / 2 * {( X - M Y )}^{2} / {S}^{2} ) ,$$

where X is a coordinate vector of the representation space, exp( ) is the known exponential function, and N is a normalization factor. If only a small number of parameters are included in such a Gaussian function, these can usually be determined quickly.

Alternatively or additionally, a so-called Gaussian mixture model can be used as a density function. For example, a Gaussian function parameterized by a mean value MY and a covariance matrix

$$F ( X ) = N * exp ( - 1 / 2 * {( X - M Y )}^{T} * {\sum }^{- 1} * ( X - M Y ) ) ,$$

where X denotes a coordinate vector of the representation space, N denotes a normalization factor, and the superscript T denotes a vector transposition. A Gaussian mixture model is often referred to as a GMM for short. Compared to radially symmetric density functions, Gaussian mixture models are advantageous in that they also allow good modeling of non-circular clusters. The covariance matrix Σ can be learned for a particular cluster by a so-called expectation-maximization procedure.

According to an embodiment of the invention, on the basis of the distribution of the training data, a first confidence region can be determined in the representation space, which comprises a predetermined proportion of the training data. Furthermore, on the basis of a distribution of the input signals in the representation space, a second confidence region can be determined, which comprises a predetermined proportion of the input signals. This allows a deviation of the second confidence region from the first confidence region to be determined, and the alarm signal can be output depending on the determined deviation. The deviation can be determined in particular by a distance, e.g., a Euclidean distance or by a degree of overlap of the first and second confidence regions. In addition, the deviation can be determined using a calculation of a so-called Kullback-Leibler divergence. Alternatively or in addition, input signals from the first confidence region and input signals from the second confidence region can both be fed into the machine learning module and the respective output signals can be compared to determine the deviation.

According to an embodiment of the invention, the machine learning module and the additional input layer can be encapsulated in a software container, in particular in a key- or signature-protected software container. The software container may be designed such that the machine learning module or the additional input layer lose their function if the software container is separated.

### BRIEF DESCRIPTION

Some of the embodiments will be described in detail, with references to the following Figures, wherein the designations denote like members, wherein:

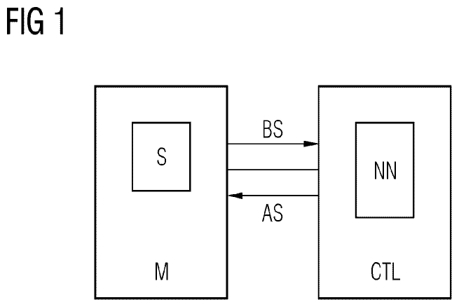

FIG. 1 shows a control of a machine by a machine learning module,

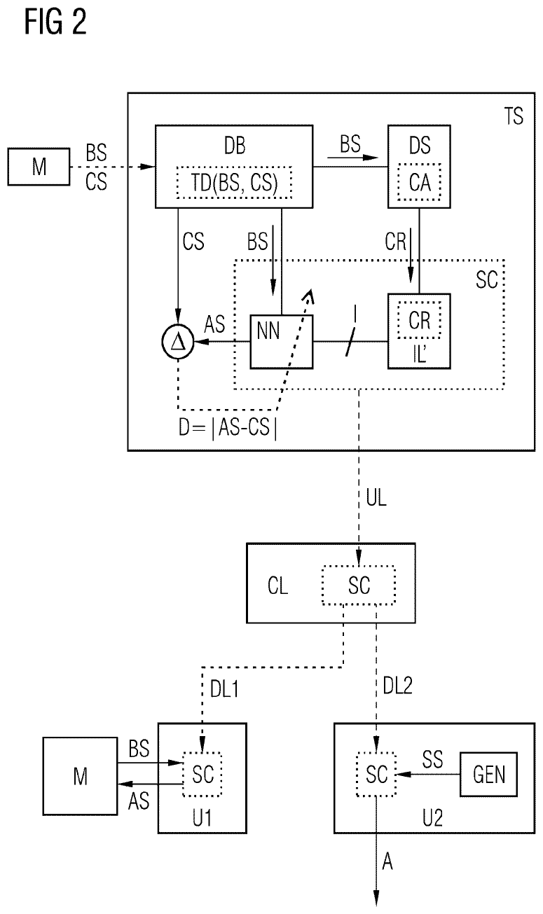

FIG. 2 shows a protection system according to embodiments of the invention for a machine learning module,

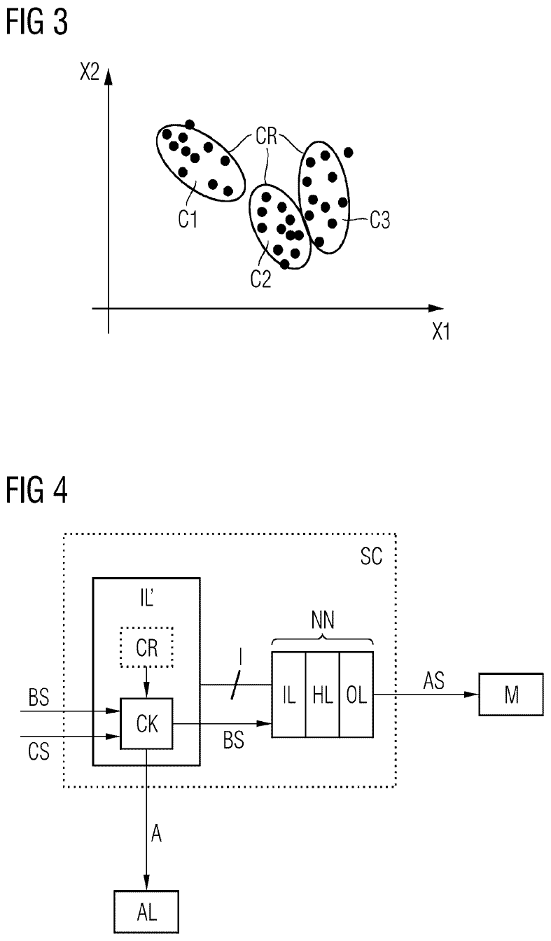

FIG. 3 shows a confidence region in a representation space of operating signals and

FIG. 4 shows an operation of a machine learning module protected according to embodiments of the invention.

Where the same or corresponding reference signs are used in the figures, these reference signs refer to the same or corresponding entities, which can be implemented or configured in particular as described in connection with the relevant figure.

### DETAILED DESCRIPTION

FIG. 1 illustrates control of a machine M by a trained machine learning module NN in a schematic representation. In embodiments, the machine M can be or comprise a robot, an engine, a manufacturing plant, a machine tool, a turbine, an internal combustion engine and/or a motor vehicle. For the present exemplary embodiment, it is assumed that the machine M is a manufacturing robot.

The machine M is controlled by a machine controller CTL connected to it. The latter is shown in FIG. 1 externally to the machine M. Alternatively, the machine controller CTL can also be fully or partially integrated into the machine M.

The machine M has a sensor system S, which continuously measures the operating parameters of the machine M as well as other measured values. The measured values determined by the sensor system S are transferred from the machine M to the machine controller CTL together with other operating data of the machine M in the form of operating signals BS.

The operating signals BS comprise in particular sensor data and/or measured values of the sensor system S, control signals of the machine M and/or status signals of the machine M. The status signals specify in each case an operating state of the machine M or of one or more of its components, over time.

In embodiments, the operating signals BS can be used to quantify a power, a rotation speed, a torque, a movement speed, a force exerted or acting, a temperature, a pressure, a current resource consumption, available resources, a pollutant emission, vibrations, wear and/or load on the machine M or on components of the machine M. In an embodiment, the operating signals BS are each represented by one or more numerical data vectors and transferred in this form to the machine controller CTL.

The machine controller CTL additionally has a trained machine learning module NN for controlling the machine M. The machine learning module NN is trained to output, on the basis of a supplied input signal, an output signal by which the machine M can be controlled in an optimized manner. For training such a machine learning module NN, a wide range of efficient machine learning methods is available, in particular methods for reinforcing learning, which is often also called reinforcement learning. The training of the machine learning module NN is discussed in more detail below. The machine learning module NN can be implemented in particular as an artificial neural network.

To control the machine M, output signals AS, in the form of numerical data vectors, are derived from the operating signals BS using the trained machine learning module NN. The output signals AS or signals derived from them are then transferred as control signals to the machine M in order to control the latter in an optimized manner.

FIG. 2 illustrates a protection system according to embodiments of the invention for a machine learning module NN for controlling the machine M. The machine learning module NN, e.g., an artificial neural network, is trained in a training system TS to output an output signal AS, by which the machine M can be controlled in an optimized manner. The training is performed using a large amount of training data TD taken from a database DB.

In the present exemplary embodiment, the training data TD contains pairs each consisting of a training operating signal BS of the machine M and an associated control signal CS of the machine M, which are each represented by numerical data vectors. Each control signal CS represents the particular control signal by which the machine M is controlled in an optimized manner when the associated operating signal BS is present. The training data TD can be determined, for example, from an operation of the machine M, from an operation of a machine similar thereto, or from a simulation of the machine M.

Training here shall be understood generally to mean an optimization of a mapping from an input signal of a machine learning module to an output signal thereof. This mapping is optimized according to predefined criteria that are learned and/or to be learned during a training phase. As suitable criteria, in control models in particular, the success of a control action can be used, or in prediction models a prediction error can be used. As a result of the training, in particular, network structures of neurons of a neural network and/or weights of connections between the neurons can be adjusted or optimized in such a way that the predefined criteria are satisfied as fully as possible. The training can thus be understood as an optimization problem.

A wide range of efficient optimization methods are available for such optimization problems in the field of machine learning, in particular gradient-based optimization methods, gradient-free optimization methods, back-propagation methods, particle swarm optimizations, genetic optimization methods and/or population-based optimization methods. In embodiments, trainable models can be artificial neural networks, recurrent neural networks, convolving neural networks, perceptrons, Bayesian neural networks, autoencoders, variational autoencoders, Gaussian processes, deep learning architectures, support vector machines, data-driven regression models, K-nearest-neighbor classifiers, physical models, and/or decision trees.

To train the machine learning module NN, the operating signals BS contained in the training data TD are fed to the machine learning module NN as input signals. In the course of the training, neural weights of the machine learning module NN are adjusted by one of the above-mentioned optimization methods in such a manner that the machine Mis controlled in an optimized manner by the output signals AS derived from the input signals BS by the machine learning module NN. For this purpose, in the present exemplary embodiment, the output signals AS are compared with the associated control signals CS contained in the training data TD and a respective distance D between these signals is determined. For example, the distance D can be determined as a Euclidean distance between the representing data vectors, or another norm of the difference between them, according to D=|AS−CS|.

As indicated in FIG. 2 by a dotted arrow, the distances D are fed back to the machine learning module NN. Its neuronal weights are then adjusted such that the distance D is minimized, at least in the statistical mean.

Alternatively or in addition, a reinforcement learning method can be used for training the machine learning module NN. In this case, the machine M or a simulation of the machine M can be controlled by the output signals AS, wherein the performance of the machine Mis continuously measured or otherwise determined. For example, the performance can be determined as an efficiency, a throughput, an execution speed or other parameters relevant to the operation of the machine M. The neural weights of the machine learning module NN are then adjusted to optimize the performance.

Furthermore, the operating signals BS contained in the training data TD are fed into a density estimator DS of the training system TS. The density estimator DS is used to determine a statistical distribution of the operating signals BS fed in—and thus of the training data TD—in a representation space of the operating signals BS.

The representation space is a vector space of the data vectors representing the operating signals BS and is usually high-dimensional. The statistical distribution is determined by the density estimator DS in a spatially resolved form with respect to the vector space.

On the basis of the determined distribution, it is to be checked during later use of the machine learning module NN whether the input signals supplied to the machine learning module NN have a similar distribution to the operating signals BS of the training data TD. A similar distribution suggests a correct operation of the machine learning module NN for controlling the machine M. By contrast, a significant deviation from the distribution of the training data TD is an indication of a systematic or randomized sampling of the representation space and thus an indication of an attempted model extraction.

To determine the distribution of the operating signals BS or the training data TD, the density estimator DS performs a cluster analysis CA. In this case, the operating signals BS or the training data TD are grouped into different clusters, wherein one cluster center is determined for each cluster. For the cluster analysis, the density estimator can be trained in particular by unsupervised machine learning methods, e.g., by a so-called k-means method.

For a particular cluster center, a distribution of the operating signals or training data of the relevant cluster in the representation space can then be represented by parameterizing a predetermined density function F. The cluster-specific density function F is parameterized, by fitting to the distribution of the operating signals or training data, by the respective cluster center and by a variance of the operating signals or training data belonging to the respective cluster.

In the present exemplary embodiment, a so-called Gaussian mixture model is used as the density function F. The latter makes it possible to model even non-circular distributions or variances around cluster centers very well. Such a non-circular variance is represented here by a so-called covariance matrix.

As a cluster-specific density function F according to the Gaussian mixture model, a Gaussian function

$$F ( X ) = N * exp ( - 1 / 2 * {( X - M Y )}^{T} * {\sum }^{- 1} * ( X - M Y ) )$$

parameterized by a mean value MY and a covariance matrix Σ can be used, wherein X denotes a coordinate vector of the representation space, N denotes a normalization factor and the superscript T denotes a vector transposition. The covariance matrix Σ can be learned for a particular cluster by a so-called expectation-maximization procedure.

A density field defined in the representation space can be represented by an optionally weighted addition of the density functions F of the various clusters. Such a density field represents a density and thus a distribution of the operating signals BS or the training data TD as a function of the location in the representation space.

The density field is used by the density estimator DS to determine a confidence region CR in the representation space. The confidence region CR is determined in such a way that it comprises a predetermined proportion of e.g., 90%, 95% or 99% of the operating signals BS or the training data TD.

Alternatively or additionally, the part of the representation space in which the density field has a value above a predetermined density threshold value can be determined as the confidence region CR. For example, the confidence region CR can be represented by one or more centers together with a respective radius and/or by a geometric outline and stored.

FIG. 3 illustrates such a confidence region CR in a representation space of operating signals defined by coordinates X1 and X2. The respective operating signals are represented by small filled circles without reference signs. The cluster analysis groups the operating signals into three different clusters C1, C2 and C3. For each of the clusters C1, C2 and C3, the distribution of the operating signals belonging to the respective cluster C1, C2 and C3 is modeled by a cluster-specific density function F. Using a Gaussian mixture model also allows non-circular, here ellipsoidal distributions, to be modeled. Based on the modeling density functions F, a confidence region CR is determined as a union of ellipsoidal regions of the representation space, which contains almost all the operating signals.

As FIG. 2 further illustrates, the determined confidence region CR is stored in an additional input layer IL′ for the machine learning module NN. The additional input layer IL′ can be designed as a neural layer, as a software layer, as an input routine for the trained machine learning module NN and/or as a callable routine for executing the trained machine learning module NN.

The additional input layer IL′ is added to the trained machine learning module NN by the training system TS and is coupled to it via an interface I. In order to protect the interface I against unauthorized access, the trained machine learning module NN together with the additional input layer IL′ is encapsulated by the training system TS in a software container SC, protected by key and/or signature. The interface I can be protected by encryption or obfuscation, for example. The software container is designed such that the machine learning module NN and/or the additional input layer IL′ lose their functions if the software container SC is separated.

The software container SC thus protected can then be passed on to users. For this purpose the software container SC is transmitted from the training system TS by an upload UL into a cloud CL, in particular into an app store of the cloud CL.

From the Cloud CL or its app store, the software container SC is downloaded to a system U1 of a first user by a first download DL1 and to a system U2 of a second user by a second download DL2.

For the present exemplary embodiment, it is assumed that the first user wants to control the machine M according to the intended purpose by the protected machine learning module NN on his/her system U1. In contrast, the second user wants to perform an unauthorized model extraction on the trained machine learning module NN on his/her system U2.

The system U1 receives the current operating signals BS of the machine for controlling the machine M and feeds them into the software container SC. In the software container SC, the additional input layer IL′ checks whether the input signals BS are sufficiently covered by the operating signals contained in the training data TD. A sequence of the check is explained in more detail below.

If, in the present exemplary embodiment, the operating signals BS, like the training data TD, originate from the machine M, it is to be expected that the operating signals BS and the training data TD will have a similar distribution in the representation space. Accordingly, the operating signals BS are evaluated by the additional input layer IL′ as being sufficiently covered, which suggests an intended normal operation of the trained machine learning module NN. As a result, the machine M can be controlled by output signals AS of the trained machine learning module NN as desired by the first user.

Unlike in the case of the first user, synthetic sampling signals SS are generated in the system U2 of the second user by a generator GEN as input signals for the trained machine learning module NN in order to systematically sample the representation space. As already described above, the input signals supplied to the software container SC are checked by the additional input layer IL′ to determine whether they are sufficiently covered by the distribution of the training data TD.

Given that such sampling signals SS usually have a different statistical distribution than the real operating signals of the machine M used for the training, it can be assumed that a statistically significant proportion of the sampling signals SS lies outside the confidence region CR. This is detected by the additional input layer IL′ and evaluated as an indication of an unauthorized model extraction. As a result, an alarm signal A is transmitted, for example to a creator of the trained machine learning module NN, by the additional input layer IL′. The alarm signal A can be used to inform the creator of the trained machine learning module NN about the attempt to perform a model extraction.

As an alternative or in addition to the output of the alarm signal A, on detection of an extraction attempt the input signals, in this case SS, can be distorted by the additional input layer IL′ in such a way that the resulting output signals of the machine learning module NN are not suitable for successfully training a new machine learning module. To perform the distortion, the input signals can be replaced in particular wholly or partially by random values before being passed on to the trained machine learning module NN.

FIG. 4 illustrates an operation of a machine learning module NN protected according to embodiments of the invention. The latter, as mentioned above, is encapsulated in a software container SC together with the additional input layer IL′. The machine learning module NN comprises a neural input layer IL, one or more hidden neural layers HL, and a neural output layer OL. The additional input layer IL′ is located upstream of the machine learning module NN and coupled to the input layer IL via the interface I.

Either operating signals BS or sampled signals SS are supplied to the software container SC as input signals. As mentioned above, it is assumed that the operating signals BS are supplied during a correct usage of the machine learning module NN, while the sampled signals SS are supplied in the event of an attempted model extraction.

Instead of being fed to the machine learning module NN as input signals, the additional input layer IL′ intercepts the signals BS or SS' and feeds them to a checking module CK of the additional input layer IL′. The input signals BS or SS supplied are checked by the checking module CK to determine whether they are sufficiently covered by the training data TD. For this purpose, the checking module CK determines, on the basis of the confidence region CR stored in the additional input layer IL′, whether a location of a given input signal in the representation space is within or outside the confidence region CR. If a location of a given input signal is within the confidence region CR, a coverage value of 1 is assigned to this operating signal. If the respective location is outside the confidence region CR, the relevant operating signal is assigned a value less than 1, which also decreases reciprocally, for example, with a distance of the respective location from the confidence region CR.

For the coverage values thus determined, the checking module CK determines a total coverage value for the input signals BS or SS, which quantifies a total coverage of the input signals BS or SS by the training data TD. For example, an optionally weighted sum of the individual coverage values and/or an average coverage value can be determined as the total coverage value.

The calculated total coverage value is compared with a predetermined coverage threshold value by the additional input layer IL′. Any undershooting of the coverage threshold is considered an indication of an unauthorized model extraction. Otherwise, an intended normal operation is diagnosed.

As already mentioned above, it is to be expected that when operating signals BS of the machine M are fed in, a high coverage by the training data TD exists and therefore normal operation is detected by the additional input layer IL′. In this case, the input signals BS are fed from the additional input layer IL′ into the input layer IL of the machine learning module NN and a resulting output signal AS of the machine learning module NN is output for controlling the machine M.

In contrast, when the sampled signals SS are fed in, it can be assumed that in many cases they will be outside the confidence region CR and therefore, as outlined above, will be evaluated by the additional input layer IL′ as an attempted model extraction. In this case, the checking module CK outputs an alarm signal A, for example, to an alarm transmitter AL of a creator of the trained machine learning module NN.

Paral to this, the sampled signals provided as input signals SS are distorted and/or wholly or partially replaced by random signals by the checking module CK and fed into the input layer IL of the machine learning module NN in this form. By distorting the input signals, a model extraction using the trained machine learning module NN can be effectively prevented.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for theft protection of a machine learning module, which is trained on the basis of training data to derive control signals for controlling a machine from operating signals of the machine, wherein
a) a distribution of the training data in a representation space of the operating signals is determined in spatial resolution;
b) the machine learning module is extended by an additional input layer;
c) the extended machine learning module is transmitted to a user;
d) when input signals are fed into the extended machine learning module, a location of a respective input signal in the representation space is determined by the additional input layer;
e) depending on the distribution of the training data a coverage value specifying coverage of the location of each input signal by the training data is determined; and
f) an alarm signal is output depending on the determined coverage values.

2. The method as claimed in claim 1, wherein
the distribution of the training data is stored in the additional input layer as a spatially resolved density field; and
that a density value of the density field at the location of the respective input signal is determined as the respective coverage value.

3. The method as claimed in claim 1,
wherein on the basis of the distribution of the training data, a confidence region is determined in the representation space, which comprises a predetermined proportion of the training data,
that the confidence region is stored in the additional input layer, and
that the respective coverage value is determined depending on the distance of the location of the respective input signal from the confidence region.

4. The method as claimed in claim 1,
wherein the distribution of the training data is determined by a density estimator.

5. The method as claimed in claim 4, wherein by the density estimator
the training data is grouped into clusters by a cluster analysis;
a cluster center is determined for each cluster; and
a distribution of the training data of the relevant cluster in the representation space for each cluster center is represented by parameterizing a predetermined density function.

6. The method as claimed in claim 5, wherein
a radially symmetric distribution function is used as the density function.

7. The method as claimed in claim 5, wherein
a Gaussian mixture model is used as the density function.

8. The method as claimed in claim 1, wherein
on the basis of the distribution of the training data, a first confidence region is determined in the representation space, which comprises a predetermined proportion of the training data;
that on the basis of a distribution of the input signals in the representation space, a second confidence region is determined, which comprises a predetermined proportion of the input signals;
that a deviation of the second confidence region from the first confidence region is determined; and
that the alarm signal is output depending on the determined deviation.

9. The method as claimed in claim 1, wherein
the machine learning module and the additional input layer are encapsulated in a software container.

10. A protection system for protecting a machine learning module against theft, configured to carry out all method steps of a method as claimed in claim 1.

11. A computer program product, comprising a computer readable hardware storage device having computer readable program code stored therein, said program code executable by a processor of a computer system to implement a method as claimed in claim 1.

12. A machine-readable storage medium having a computer program as claimed in claim 11.
